(19) United States
(12) Patent Application Publication
(10) Pub. No.: US 2020/0324700 A1
(43) Pub. Date: Oct. 15, 2020

(54) CAMERA System FOR USE ON VEHICLE

(71) Applicant: YILMA ASFAW, BELLAIRE, TX (US)

(72) Inventor: YILMA ASFAW, BELLAIRE, TX (US)

(73) Assignee: Yilma Asfaw, Bellaire, TX (US)

(21) Appl. No.: 16/124,278

(22) Filed: Sep. 7, 2018

(51) Int. Cl. B60R 1/00; H04N 5/232; H04N 5/225; B60K 37/02; G01S 13/931

(52) U.S. Cl. CPC B60R 1/00; B60K 2370/12; H04N 5/2253; H04N 5/23238; B60K 37/02; G01S 13/931; B60R 2300/105; B60R 2300/202; B60K 2370/152; B60K 2370/77; B60K 2370/176; B60R 2300/802; B60R 2300/8093; B60K 2370/178; H04N 5/23299

(57) ABSTRACT

The present invention is a single camera or multiple cameras on telescoping pole that can be mounted on top surface of vehicles such as automobiles, trucks, buses, trains, airplanes, toys etc. For easier explanation of the invention, focus is given on the application of the camera system on automobiles (cars). Four cameras mounted in different directions on the pole give wider field of view for safe operation of the vehicle. The camera system also includes a radar. The telescoping pole helps to raise the cameras unit with radar(LDAR) above the top surface of the vehicle. The first camera points to the front direction of the car, the second camera points to the rear direction of the car, the third camera points to a blind spot on the left side of the car and the fourth camera points to a blind spot on the right side the car. The inventions can be easily modified to a single or dual camera on top of pole for a cheaper alternative camera system, first camera can be mounted on the pole to show front view and the second camera may be mounted on the pole to show the rear view. The system can also keep cameras that point to the blind spots and ignore cameras facing the front and rear views.

### TECHNICAL FIELD

In general, this application is related to video camera system and display device, and more particularly but not by way of limitation to multi-directional camera device for use on vehicles. The system can be mounted and used on automobiles, trucks, buses, trains, airplanes, toys etc.

### BACKGROUND

Camera devices have long been used in vehicles to capture, display rear views, blind spot views, surrounding views of some vehicles. Latest vehicles also use front view cameras as parking aids. However, a camera system that is elevated from the tops surface of the vehicles has not been used and similar patent has not been issued.

Statistics of USA accidents and related deaths studied by IIHS (Insurance Institute for Highway Safety organization) shows that more death and accidents occur on smaller size cars of every passenger vehicle categories such as cars, pickups, SUVs. The higher accident and related deaths on smaller vehicle might on one hand be related to limited field of view for driver on smaller cars besides other factors. Drivers on big trucks can see very far away from the trucks since the vehicle is tall enough so that smaller vehicles in front do not obscure field of view. The drivers are aware of what is going on in the far distance and adjust their driving accordingly. However, drivers of smaller cars have very short field of view since most cars in front can be taller and block the far field of view of the smaller vehicles. Hence the drivers on smaller cars do not know what is going on far view of the road to make adjustment to their driving and protect accidents from happening. Sometimes smaller vehicles behind big trucks change lane without knowing whether there are some slow-moving vehicles on the lane they are driving to because the trucks in the front cover their field of view, that may cause the smaller cars to crash in to another car when changing lane. In difficult traffic jams, some drivers may jump to the roof of the car to see what is causing the traffic jam to take proper driving action such as take another route or change lane. Sometimes, smaller vehicles following big trucks may drive in to a red light without knowing the traffic light turned to red since the big trucks in front would cover their field of view and accident may happen. Moving out of parking spot can be a big challenge especially when bigger cars parked on the side of the car, bigger vehicles parked on the sides of smaller cars may obscure the field of view and drivers may not tell if cars are passing by when trying to move out of the parking spot. The present invention can also help when parking in tight spots. The invention helps to decrease traffic accidents especially traffic accident of smaller vehicles by giving drivers of smaller vehicles far and wide field of view similar to field of view of big vehicles. The far and wide field of view allows drivers to safely change lane, to safely move out of the parking spot, to safely park the car, to safely adjust driving after checking traffic conditions such as traffic accident at distance, to safely join traffic road. The present invention has four cameras pointing to different directions: one camera points to the front, one camera points rear, one camera points to the left blind spot and one camera points right blind spot. The inventions can be easily modified to a single camera on top of pole for a cheaper alternative camera system, one camera with pole can be mounted in the front part of the car and another camera with pole can be mounted at the rear part of the car to capture rear view, this configuration is good for long vehicles like buses. The inventions can be easily modified to a two-camera system by ignoring two cameras that are pointing to the blind spots on the right and left side of the car or vice versa. Generally, the invention is not limited to one or two or three or four cameras, different configurations came be done with in the present invention. Field of view of cameras may vary from camera to camera but in general most cameras have field of view that may range from few degrees to about 180 degrees. Recording device may be integrated to activate recording when needed.

### BRIEF DESCRIPTION OF THE DRAWINGS

A complete understanding of the present invention may be obtained by referencing to the following drawings in conjunction with the accompanying detailed descriptions of the present invention.

FIG. 1 is a side view of the present invention showing a car and the present invention mounted on top; with detailed A;

FIG. 2 is a detailed view from FIG. 1 showing camera system in full extension position;

FIG. 3 is a side view showing camera system in retracted position;

FIG. 4 is a side view showing camera system in retracted and folded position;

FIG. 5 is a side view showing camera system in full extension position and outer protection glass removed, with detailed B;

FIG. 6 is a detailed view from FIG. 5 showing camera system;

FIG. 7 is a perspective view showing camera system in full extension position without outer protection glass, with detailed C;

FIG. 8 is a detailed view from FIG. 7 showing camera system without outer protection glass;

FIG. 9 is a top view showing camera system without outer protection glass;

FIG. 10 is a perspective view showing camera system in full extension, with detailed D;

FIG. 11 is a detailed view from FIG. 10 showing display unit with buttons;

FIG. 12 is a block diagram to explain the car system integration with camera system and display unit

FIG. 13 is a perspective view showing vehicles, truck on traffic junction with traffic lights;

FIG. 14 is a side view showing vehicles, truck, traffic lights and increased field of view;

FIG. 15 is a perspective view showing vehicles and trucks in the parking lot;

FIG. 16 is a perspective view showing the interior of a bus with detailed E and F;

FIG. 17 is a detailed view from FIG. 16 showing display unit;

FIG. 18 is a perspective view of a car with an alternative camera system with detailed G;

FIG. 19 is a detailed view from FIG. 18 showing details of alternative camera system

### DETAILED DESCRIPTION

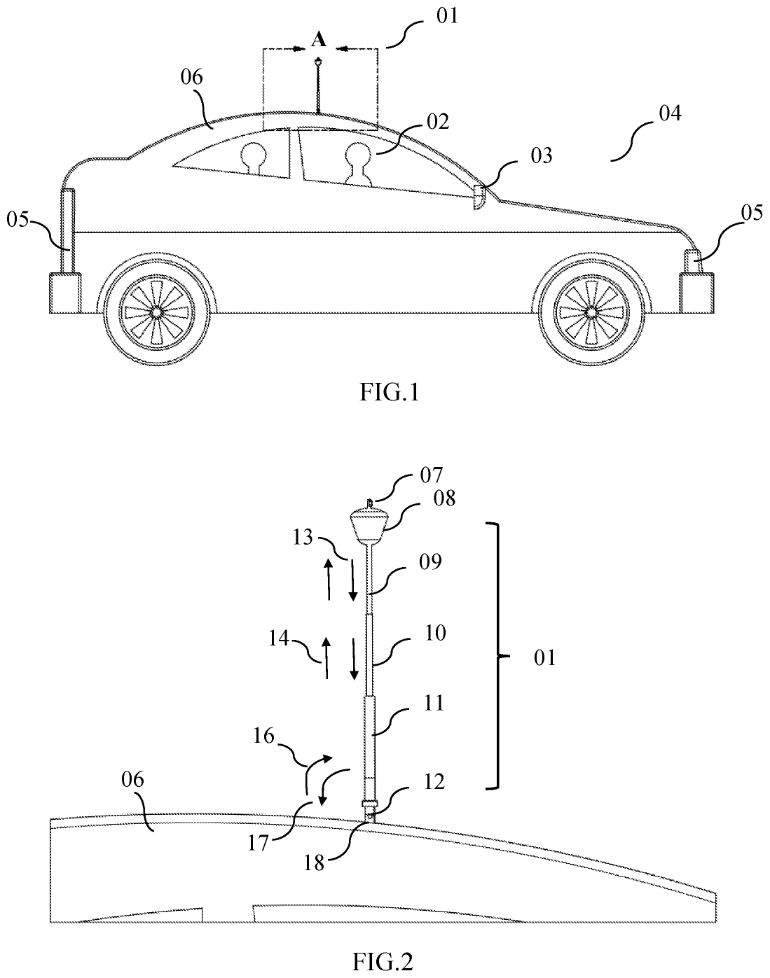

FIG. 1 shows a camera system 01 mounted on top 06 of a car 04. FIG. 2 is detailed from FIG. 1; it shows the camera system 01 in fully extended position. Even though the drawing shows the camera system mounted on the top roof 06 of the car, the system 01 can also be mounted on the hood of the vehicle but the telescoping pole needs to be longer to have a better field of view. The camera system 01 has telescoping pipes 09,10,11 base plate 18 and pine 12 to connect pole/pipe 11 with base plate 18, the base plate 18 is mounted on the car roof 06. The camera system 01 height can either be controlled by hydraulic system, linear actuator or manual system. The driver 02 can adjust the height of the camera system 01 by extending 14 the telescoping pole/pipes 09, 10 or by retracting 13 the pole/pipes 09, 10. FIG. 6, the camera system 01 has a radar 07 (or LDAR) on the top of the pole which continually sends and receives signals to detect any obstruction on the camera way then sends signal to warn the driver when the extended length of the camera system 01 is longer than the height limit of the road of obstruction; the height limit can be height of under pass, height of tunnel, height limiter pole or any other form of obstruction. The camera system 01 comprises of cameras inside the transparent camera protection cover 08, the cover can be made of plastic or glass.

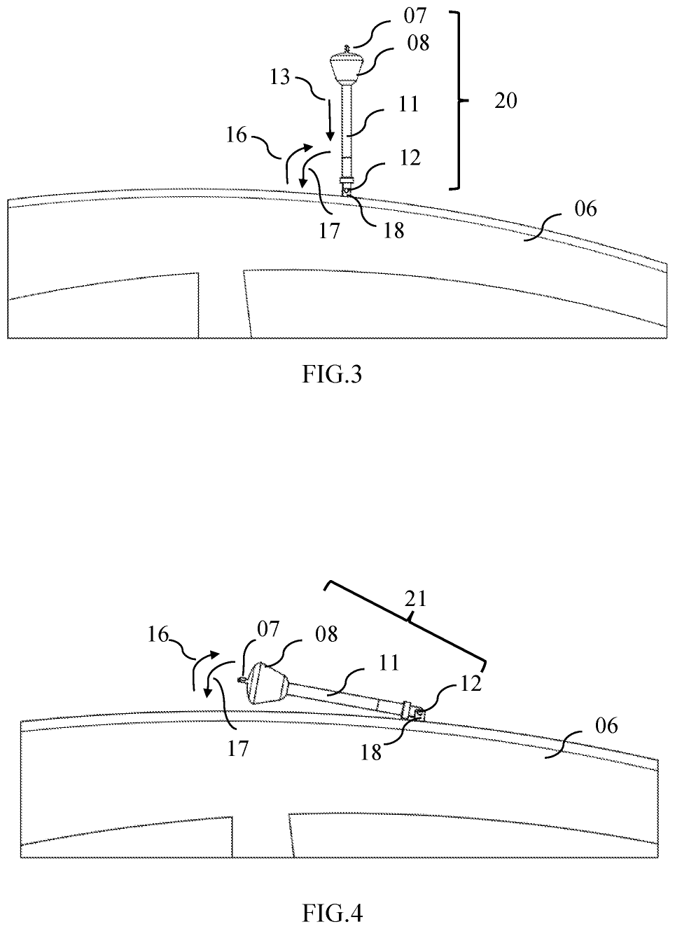

FIG. 3 shows camera system 20 in fully retracted 13 position. Pole/Pipes 09, 10,11 are telescoping pipes, the camera system 20 can be folded 17 or unfolded 16 from folded position. FIG. 4 shows the camera system 21 in fully retracted 13 and folded 17 position. When leaving the car, the driver 02 can fold 17 the camera system 20. Folding 17 and unfolding 16 of the camera system 20 can easily be done either using a mechanical system, hydraulic system, manual system or combination of different systems.

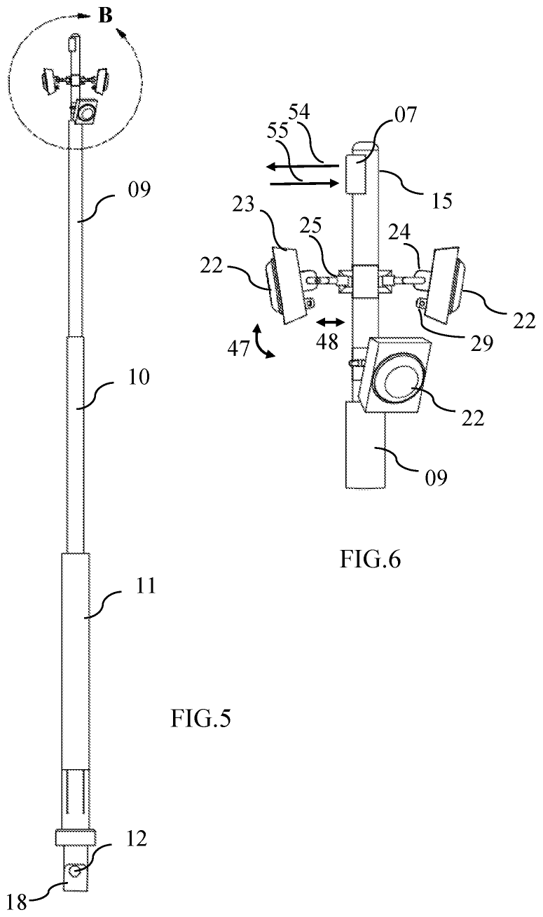

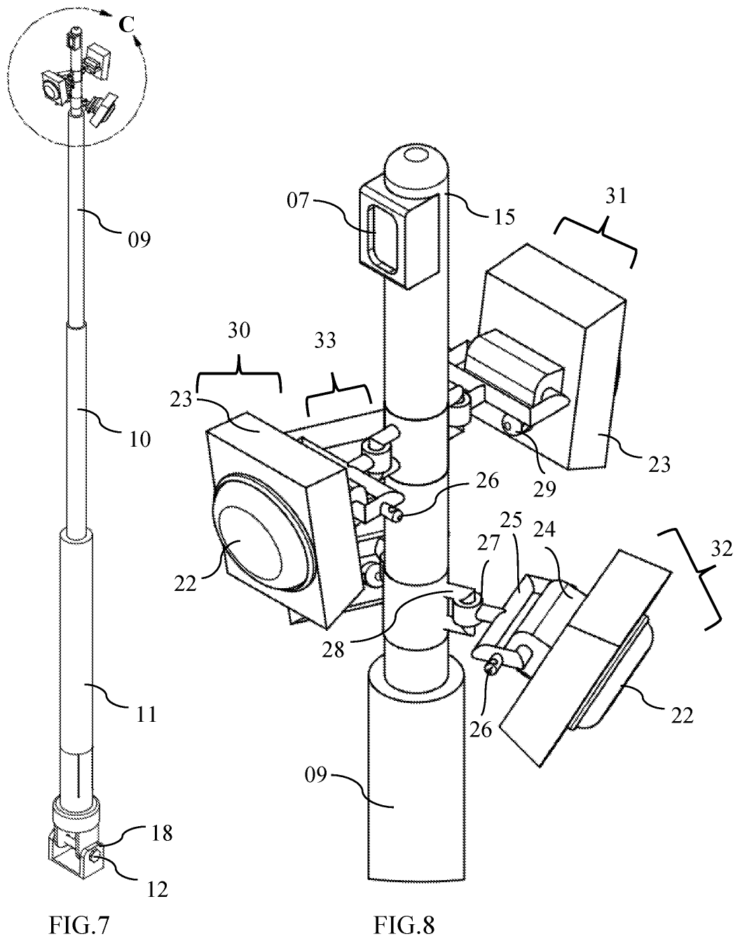

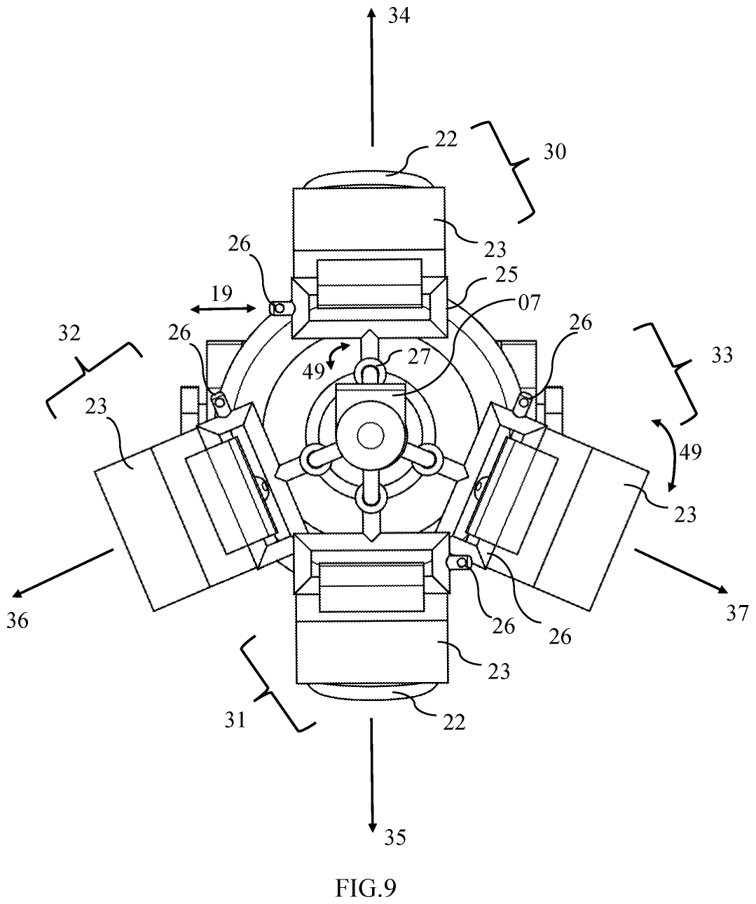

An integrated description of FIG. 5, FIG. 6, FIG. 7, FIG. 8, FIG. 9 explains the camera components better. The protection cover 08 of the camera system 01 has been removed to show the details of components inside the protection cover 08. The camera system 01 has telescoping poles/pipes 09,10,11; four cameras 30, 31, 32, 33 that are attached to the top of the pole 15; the front camera 30 is pointing to the front direction 34 of the car 04; the rear camera 31 is pointing to the back direction 35 of the car 04; the left side camera 32 is pointing to the left side blind spot direction 36 of the car 04; the right side camera 33 is pointing to the right blind spot direction 37 of the car 04; the cameras 22 has camera casing 23 which has hollow bar 24 and another bar 29 on the back; a Y shaped bar passed through hole 24 on the back of camera casing 23, a pull or push 48 (FIG. 6) on bar 29 rotates/tilts the camera view 22 up and down 47; on the other hand, a pull and push 19 (FIG. 9) on Y shaped bar 25 rotates/pan camera views 34, 35, 36, 37 in a clockwise or counter-clockwise directions 23 (FIG. 9). The Y shaped bar 25 has a hole 27 and a vertical bar 28 passes through the hole 27 for easier rotation 23 of cameras 30, 31, 32, 33 on a horizontal plan.

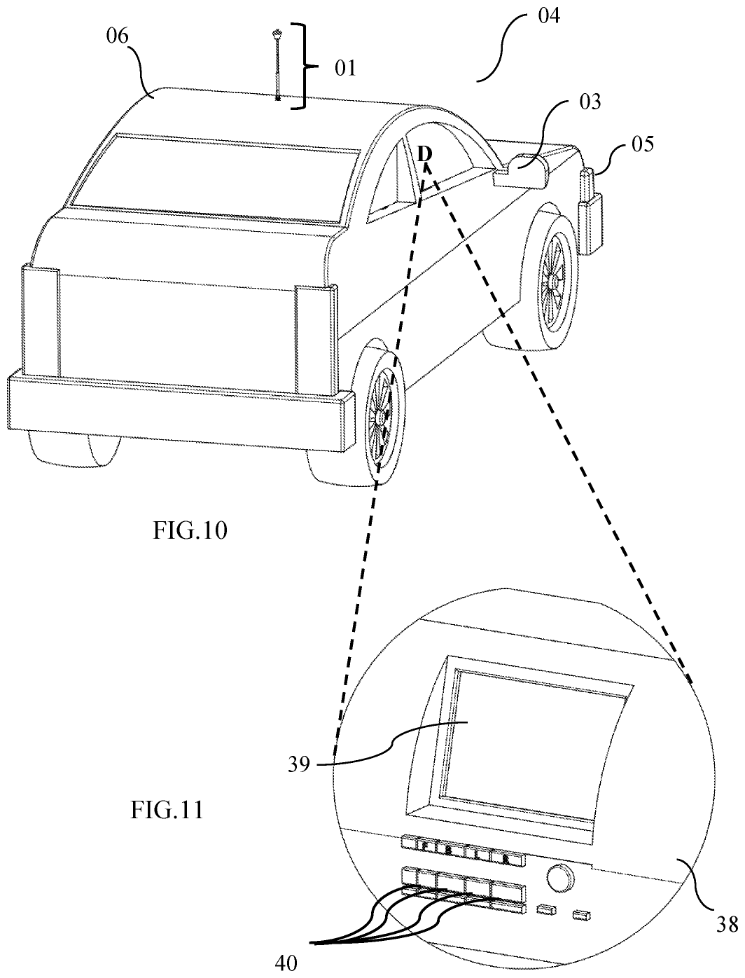

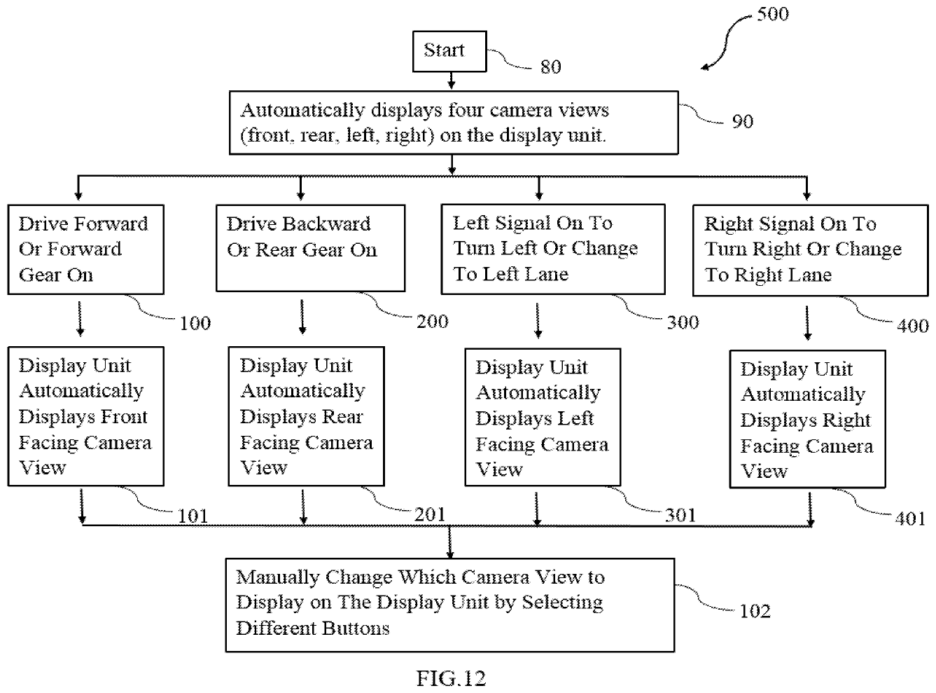

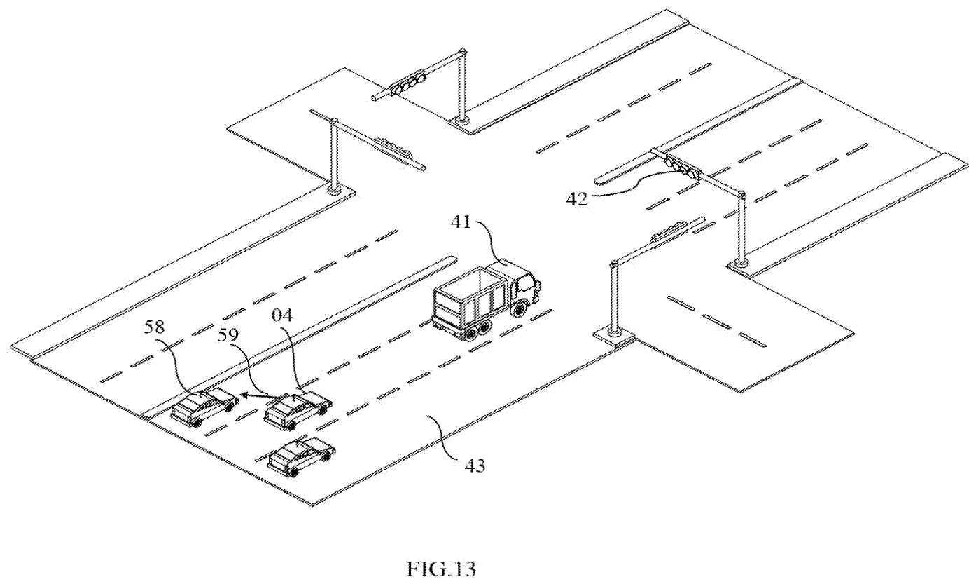

FIG. 10 shows a perspective view of the car 04 with fully extended camera system 01; the image captured on four cameras 30, 31, 32, 33 displays on the display unit 39 which is located on the car 01 dashboard 38 (FIG. 10); the user has an option to display any of the four cameras 30, 31, 32, 33 by selecting the buttons 40 below the display unit 39; the first button (on left of button with letter F) may be pressed to display the all camera views 30, 31, 32, 33 in a cross shape preferably or in any preferred sequence or pattern. Button with letter F may be pressed to display the front facing 34 camera 30; button with letter B may be pressed to display video/image captured by the rear facing 35 camera 31; button with letter L may be pressed to display video/image captured by left blind spot facing 36 camera 32; button with letter R may be pressed to display video/image captured by right blind spot facing 37 camera 33. FIG. 12 illustrates integration of camera system 01 and display unit 39 with the car system 04; the illustration 500 has sequences of blocks; up on the start 90 of the car engine, the display unit (FIG. 11) displays video from the four cameras 30, 31, 32, 33 preferably in a cross shape, the top branch of the cross shows view from the front view camera 30, the bottom branch of the cross shows view from the rear view camera; the left branch of the cross shows view from the left side camera 32; the right branch of the cross shows view from the right side camera 33. When driving forward 100 or change of driving gear to drive, the display unit 39 (FIG. 11) shows image captured by front camera 30 automatically 101; when driving backward 200 or change driving gear to reverse, the display unit 30 shows image captured by the rear camera 31 automatically 201; when activating the left side light signal 300, the display unit 39 shows image captured by the left side camera 32 automatically 301; when activating the right side 05 light signal 400, the display unit 39 shows image captured by the right side camera 33 automatically 401; even though the display unit 39 displays images captured by different cameras 30, 31, 32, 33 automatically based on current driving gear or light signals; users have option to manually 102 press buttons 40 to decided which image capture by camera 30, 31, 32, 33 to display on display unit 39.

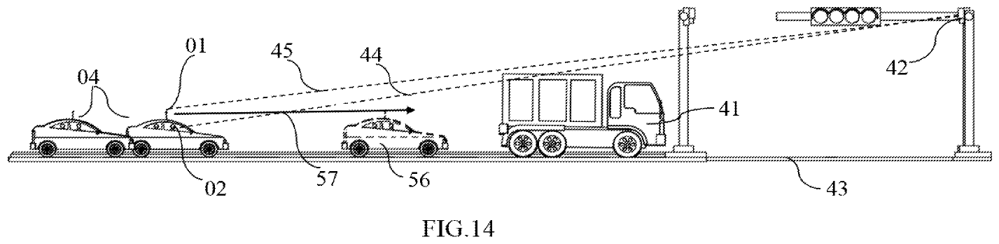

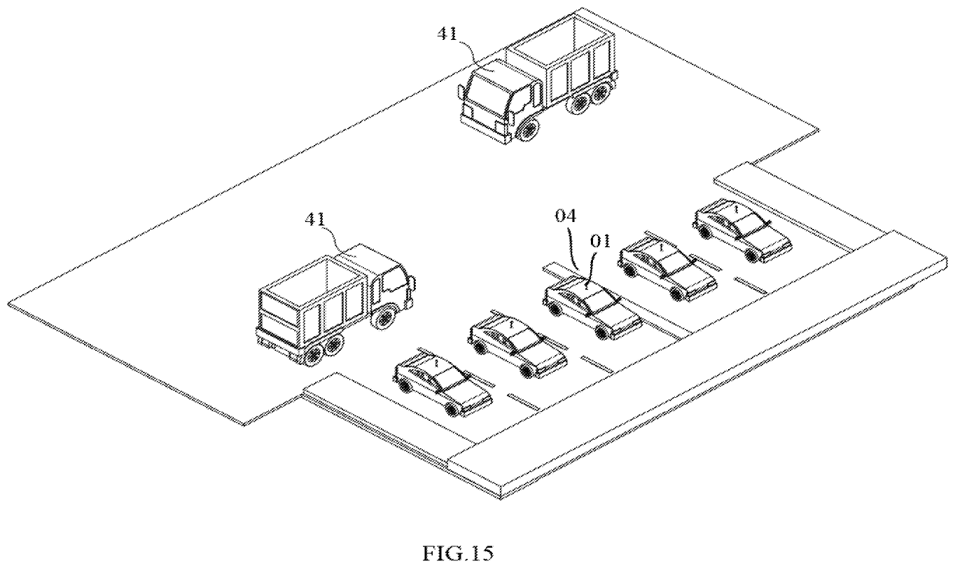

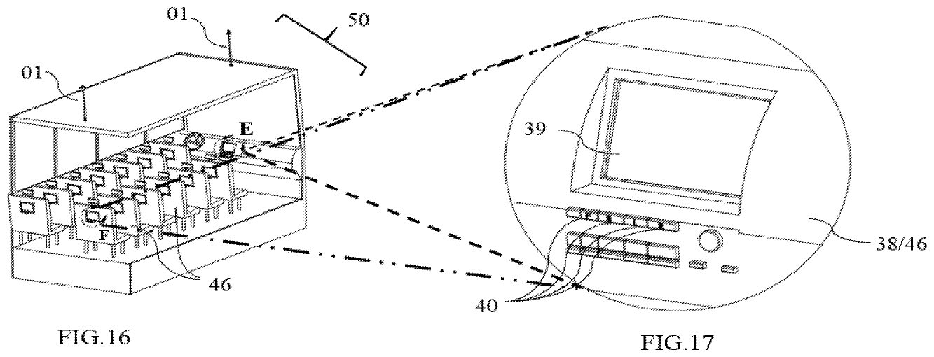

FIG. 13 shows a perspective view of traffic on road 43 intersection where the truck 41 in the front obscure field of view of car 04 behind it. The present invention gives a better field of view 59 in the front direction and blind spots so that driver on car 04 can easily spot car 58 on left and right lanes to be able to make decision for safe lane change; side mirror 03 (FIG. 1) may not show the car on the left and right. FIG. 14 shows that without the present invention 01, the driver 02 in the car 04 could not able to see the status of the traffic light 42 because the truck 41 in front obscures the field of view 44. However, the present invention 01 gives the driver 02 a far and wider field of view 45 and because of that the driver 02 can see the status of the traffic light 42; when small or medium size car present in front of the car 04, the driver 02 will have way better field of view 57 over the car 56 in the front that allows to drive safely and adjust driving based on traffic condition in the far distance. FIG. 15 shows that the present invention 01 gives a better field of view when moving out of the parking spot. The inventions also help when parking. Traditional cameras which usually mounted close to license place on the back of the car 04 may not show the coming trucks 41. FIG. 16 shows that on buses 50, two cameras 01 may be used, one in the front of the bus 50 and another one on the back, most people enjoy to seat close to the driver because traveling is more fun since view in the front is much better than view on the side of the bus so tourist buses or buses that travel long distances may equip with display units 39 on the back of each seat 46, the display unit 39 is similar to display unit 39 on the dashboard 38, passengers may press buttons 40 (FIG. 17) to select which camera view to display on the display unit 39. Extension 14, retraction 13, folding 17 and unfolding 16 of the camera system 01 can be controlled by hydraulic system, linear actuator, manual or combination of different methods.

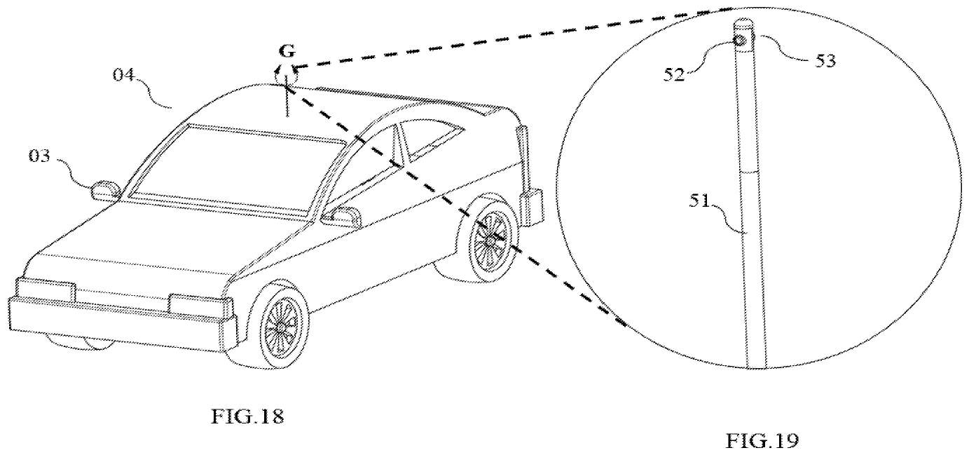

FIG. 18 and FIG. 19 shows an alternative camera system where a single pole 51 support two cameras 52,53; camera 52 points to the front direction of the car and camera 53 points to the back-side view of the car 04. The alternative camera system 51,52,53 will be cheaper alternative as compared to four camera system 30,31,32,33 described above. Although, field of view of cameras may vary from camera to camera, in general most cameras have field of view that may ranges from few degrees to about 180 degrees. Wide angle camera 52,53 would give a better field of view in the present invention. Generally, the camera panning, and tilting can be controlled by linear actuator, hydraulic system, manual or combination of different methods.

A, an, the, might be used interchangeably. Pipes, pole might be used interchangeably in the application. In contrast to the prior art, the present invention provides a vehicle with a camera system to allow driver to have far and wide field of view while driving that in turn help to adjust driving accordingly and avoid accidents. Although various embodiments of the system and method of the present invention have been described in the accompanying drawings and descriptions, it will be understood that the invention is not limited to the embodiments disclosed, but is capable of numerous rearrangements, modifications and substitutions without departing from the spirit of the invention as set forth herein.

1. A camera system for use on vehicles for driving safety. The system comprising:
One or more cameras, a telescoping pole, a radar (LDAR) system which can be mounted on top of telescoping pole, a display unit displays images captured by the cameras, the system can be mounted on the top body of vehicles such on automobiles, trucks, buses, trains, airplanes, toys etc.

2. The camera system of claim 1, wherein the camera system has a radar (or LDAR) to detect obstacles on the road and warn the driver whenever the extended telescoping pole/piles is taller than obstacles such as overpass opening, tunnel or any other height limiter on the road.

3. The camera system of claim 1, wherein the cameras have connections that allow changing of camera directions (pan) and camera tilting.

4. The camera system of claim 1, wherein the cameras point to different direction: to the front, to rear, to left blind spot and to right blind spot directions of the vehicle.

5. The camera system of claim 1, wherein the cameras are mounted on top of telescoping pole/pipes where the telescoping pipes can be extended, retracted and folded to adjust height easily.

6. The camera system of claim 1, wherein the cameras system may be mounted on top body of the vehicle for better field of view, the longer the camera height from the ground is the better field of view. However, the camera system can also be mounted on the hood of the vehicle or any other parts but the telescoping pipes need to be even longer to have a better field of view.

7. The camera system of claim 1, wherein the captured images are displayed in the display unit mounted on the dashboard of the vehicles; in case of buses or long vehicles, display units may also be mounted on the back of the seats.

8. The display unit of claim 7, wherein the display unit has buttons which allows users to select which camera captured image to display on the display unit.

9. The display unit of claim 7, wherein up on start of the vehicle, the display unit shows all images being capture by the four cameras preferably in a cross shape; image capture by the front camera displays on the top of the cross shape, image capture by the rear facing camera displays on the bottom of the cross shape, image capture by the left side camera displays on the left side of the cross shape, image capture by the right side camera displays on the right side of the cross shape.

10. The display unit of claim 7, wherein the display unit automatically displays image capture by front camera when driving forward, the display unit automatically displays image capture by rear camera when driving backward, the display unit automatically displays image capture by the left side camera when the left side signal is on, the display unit automatically displays image capture by right camera when the right side signal is on, user also have option to manually select which camera view to display by selecting different buttons.

11. An alternative camera system for use on vehicles for driving safety, the system comprising:
two cameras configuration with none telescoping pole or pipe.

12. The camera system of claim 11, wherein cameras with wide field of view close to 180 degrees is better
